(19) United States
(12) Patent Application Publication
(10) Pub. No.: US 2011/0088516 A1
(43) Pub. Date: Apr. 21, 2011

(54) CONTAINER LID OPENING DEVICE

(76) Inventors: Tadahiko Nakanishi, Hiroshima (JP); Shizuki Nagao, Chiba (JP)

(21) Appl. No.: 12/996,821

(22) PCT Filed: May 20, 2009
(86) PCT No.: PCT/JP2009/002227

§ 371 Date: Dec. 8, 2010

(30) Foreign Application Priority Data
Jun. 11, 2008 (JP) 2008-153077

(51) Int. Cl. B67B 7/18

(52) U.S. Cl. 81/3.4

(57) ABSTRACT

A device for rotating and opening a screw cap of a container is provided. A lid opening device 1 constructed from a plate material is provided with a circular arc-shaped section 11 formed by bending a plate surface into a circular arc shape, and two opposed extending sections 3 continuously extending from opposite ends of the circular arc-shaped section 11. One of the extending sections 3 includes a twisted section 4 that is formed by twisting the plate surface and has a plate side edge facing the other extending section 3. On the plate side edge of the plate of the twisted section 4 is formed a contact section 6 that is to be in contact with the outer peripheral surface of a screw cap of a container in order to grasp and rotate the screw cap in cooperation with the other extending section 3.

The present invention relates to a lid opening device capable of easily opening screw caps of bottles of juice, energy drinks, etc., and more particularly to a lid opening device capable of easily opening lids of pull-top cans such as beer cans and juice cans, or inside caps of seasoning bottles and the like.

### BACKGROUND ART

Although a pull-top type has been often employed for beverage cans such as beer cans and juice cans, this type is sometimes avoided because pull-top cans are difficult to open for persons having less strength of their fingers, including infants, elderly persons and sick persons, and may damage nails for persons with thin and weak nails or women wearing nail polish.

A screw cap has been widely employed for PET bottles and other bottles of juice, and energy drinks, etc. To open the screw cap, one need to grasp and rotate the cap, and sometimes, cannot open the cap without a large force by finger or hand. Thus, physically weak elderly persons and children often fail to the cap.

For this reason, there are various lid opening devices available for the pull-tops and the screw caps.

For example, Patent document 1 describes a lid opening device including a ring section formed by bending a plate material into a ring-like shape and a pair of opposed holding sections extending outward from both ends of the ring section, in which a hook section is formed at one holding section. When a screw cap is detached from a bottle, the ring section is wound around the cap and fastened to the cap while applying a holding force to both extending sections, and in this state, a rotational force is exerted on both the extending sections, thereby rotating the cap. When a pull-top can is opened, the hook section of one extending section is engaged with a pull-tab and the pull-tab is pulled up by leverage using a front end of the extending section as a fulcrum.

Patent document 2 describes a lid opening device in which opposed semicircular sections are formed in the middle of a pair of long plate sections, which are connected to each other at a U-like folded section and extend substantially in parallel, and a hook section is formed at a front end of each of the long plate sections. When a screw cap is opened, the screw cap is grasped by the opposed semicircular sections of the long plate sections, and when a pull-top can is opened, the hook section is engaged with a pull-tab.

### Citation List

### Patent Document

PATENT DOCUMENT 1: Japanese Utility Model Registration No. 3081472

PATENT DOCUMENT 2: Japanese Utility Model Registration No. 3057251

### SUMMARY OF THE INVENTION

### Technical Problem

In the lid opening device described in Patent document 1, when the ring section is wound around an outer periphery of the screw cap and rotated, an inner peripheral surface of the ring section may slip on the outer peripheral surface of the cap, which prevents the cap from rotating.

In the lid opening device described in Patent document 2, the screw cap is grasped by the pair of semicircular sections. In Patent document 2 as in Patent document 1, inner peripheral surfaces of the semicircular sections may slip on the outer peripheral surface of the cap, which prevents the cap from rotating.

In both of Patent documents 1 and 2, since the ring section or the semicircular sections is brought into surface contact with the outer peripheral surface of the cap, a contact pressure is low and the holding force is not sufficiently exerted on the cap, resulting in that the ring section or the semicircular sections is easy to slip on the outer peripheral surface of the cap, preventing the screw cap from rotating.

Therefore, according to the present invention, there is provided a lid opening device that is easy to manufacture, has good operability and enables the screw cap to be easily rotated and opened.

### Solution to the Problem

According to the present invention, in order to solve the above-mentioned problems, a plate side edge of a lid opening device comprised of a plate material is brought into contact with at least a part of the outer peripheral surface of the cap rather than that the a plate surface of the lid opening device is brought into contact with the outer peripheral surface of the cap. As a result, a high contact pressure can be obtained even with a weak force and thus, the lid opening device becomes difficult to slip on the outer peripheral surface of the cap.

Means for solving the above-mentioned problems is a lid opening device comprised of a plate material comprising:

a circular arc-shaped section formed by bending a plate surface into a circular arc shape; and

two opposed extending sections continuously extending from opposite ends of the circular arc-shaped section, wherein:

at least one extending section includes a twisted section that is formed by bending the plate surface so that a plate side edge faces the other extending section, and a contact section that is to be in contact with an outer peripheral surface of a screw cap of a container is formed on the plate side edge of the twisted section in order to grasp and rotate the screw cap in cooperation with the other extending section.

Therefore, since the screw cap can be grasped by the contact section on the plate side edge with a high contact pressure, the lid opening device is difficult to slip on the outer peripheral surface of the cap, and the cap can be reliably rotated and opened even with a weak force.

In a preferred embodiment, a notched section is formed on the plate side edge of the twisted section and angular sections at both ends of the notched section constitute the contact section. Since the contact section is angular, the lid opening device is difficult to slip on the outer peripheral surface of the cap and the cap can be reliably rotated and opened even with a weak force.

In a preferred embodiment, the contact section is formed on the plate side edge of each of the extending sections. Thus, the lid opening device can be prevented from slipping on the outer peripheral surface of the cap more reliably, which is advantageous for reliably opening the cap with a weak force.

In a preferred embodiment, the contact sections formed on the plate side edges of the two extending sections are opposed to each other. This is more advantageous to prevent the lid opening device from slipping on the outer peripheral surface of the cap.

In a preferred embodiment, opposed grip sections are formed at both front ends of the extending sections so that the plate surfaces of the extending sections are opposed to each other. Thus, the lid opening device becomes easy to hold and the cap can be grasped with a high contact pressure merely by applying a weak force to the grip sections, which is excellent in operability.

In a preferred embodiment, a front end of at least one of the grip sections of both the extending sections is bent inward or outward to constitute a pull-tab hook to be engaged with a pull-tab in order to open a cap with pull-tab. Thus, the cap with pull-tab can be easily opened.

In a preferred embodiment, a front end of at least one of the grip sections of both the extending sections constitutes a pull-tab hook to be engaged with a pull-tab in order to open a pull-top container. Thus, the pull-top container can be easily opened.

In a preferred embodiment, a front end of one of the grip sections of both the extending sections is bent inward or outward to constitute a pull-tab hook to be engaged with a pull-tab in order to open a cap with pull-tab, and

a front end of at least one of the grip sections of both the extending sections constitutes a pull-tab hook to be engaged with a pull-tab in order to open a pull-top container.

Thus, the cap with pull-tab and the pull-top container can be easily opened.

In a preferred embodiment, a winding section to be wound around the outer peripheral surface of a cap is formed on the inner peripheral surface of the circular arc-shaped section in order to rotate the cap. Thus, the extending section as well as the circular arc-shaped section can be used to open the screw cap, which is advantageous for opening various caps.

In a preferred embodiment, the circular arc-shaped section is provided with a strength reducing section that reduces a force required to deform the circular arc-shaped section so as to reduce a radius of curvature of the circular arc-shaped section. Thus, even physically weak elderly persons and children can easily open the screw cap.

In a preferred embodiment, an engaging section to be engaged with an edge of a crown cap is provided at a front end of one grip section in order to use the grip section as a bottle opener. Thus, the grip section can be used as a bottle opener, which is versatile.

In a preferred embodiment, an engaging section to be engaged with an edge of a crown cap is provided at the circular arc-shaped section in order to use the circular arc-shaped section as a bottle opener. Thus, the circular arc-shaped section can be used as a bottle opener, which is versatile.

### ADVANTAGES OF THE INVENTION

According to the present invention, because a lid opening device comprised of a plate material includes an circular arc-shaped section formed by bending a plate surface into a circular arc shape and two opposed extending sections continuously extending from opposite ends of the circular arc-shaped section, at least one extending section has a twisted section formed by bending the plate surface so that a plate side edge faces the other extending section, and a contact section that is to be in contact with an outer peripheral surface of a screw cap of a container is formed on the plate side edge of the twisted section in order to grasp and rotate the screw cap in cooperation with the other extending section, the screw cap can be grasped with a high contact pressure and the lid opening device becomes difficult to slip on an outer peripheral surface of the cap, resulting in that the cap can be reliably rotated and opened even with a weak force.

### BRIEF DESCRIPTION OF THE DRAWINGS

FIG. 1 is a perspective view showing a lid opening device in accordance with Embodiment 1 of the present invention.

FIG. 2 is a side view showing the lid opening device in accordance with Embodiment 1.

FIG. 3 is an explanation view for explaining a usage condition of the lid opening device in accordance with Embodiment 1.

FIG. 4 is a sectional enlarged plan view of FIG. 3.

FIG. 5 is an explanation view for explaining another usage condition of the lid opening device in accordance with Embodiment 1.

FIG. 6 is an explanation view for explaining still another usage condition of the lid opening device in accordance with Embodiment 1.

FIG. 7 shows a state of a plate material prior to forming of the lid opening device in accordance with Embodiment 1.

FIG. 8 is a manufacturing process of the lid opening device in accordance with Embodiment 1.

FIG. 9 is a front view showing a lid opening device in accordance with Embodiment 2 of the present invention.

FIG. 10 is a perspective view showing a lid opening device in accordance with Embodiment 3 of the present invention.

FIG. 11 is a perspective view showing a lid opening device in accordance with Embodiment 4 of the present invention.

FIG. 12 is a perspective view showing a lid opening device in accordance with Embodiment 5 of the present invention.

FIG. 13 is a perspective view showing a lid opening device in accordance with Embodiment 6 of the present invention.

FIG. 14 is a perspective view showing a lid opening device in accordance with Embodiment 7 of the present invention.

FIG. 15 is a partial front view showing a lid opening device in accordance with Embodiment 8 of the present invention.

FIG. 16 is a perspective view showing a lid opening device in accordance with Embodiment 9 of the present invention.

FIG. 17 is an explanation view for explaining a usage condition of the lid opening device in accordance with Embodiment 9.

FIG. 18 is a perspective view showing a lid opening device in accordance with Embodiment 10 of the present invention.

FIG. 19 is an explanation view for explaining a usage condition of the lid opening device in accordance with Embodiment 10.

FIG. 20 is a perspective view showing a lid opening device in accordance with Embodiment 11 of the present invention.

FIG. 21 is an explanation view for explaining a usage condition of the lid opening device in accordance with Embodiment 11.

FIG. 22 are partial side views showing lid opening devices in accordance with other embodiments.

### DESCRIPTION OF EMBODIMENTS

Embodiments of the present invention will be described below in detail with reference to figures. Descriptions of the following preferred embodiments are essentially made by way of example only and are not intended to limit the present invention, and its application or use.

According to the present invention, because a lid opening device comprised of a plate material is provided with a twisted section and a cap is grasped with a plate side edge as a contact section, the lid opening device becomes difficult to slip on an outer peripheral surface of the cap and therefore, the cap can be easily rotated and unfastened. Although it is preferred that the twisted section and the contact section are provided on each of two extending sections, they may be provided on one of the extending sections. Further, when the lid opening device is provided with a pull-tab hook and a cap opening part that serve to open caps with pull-tab and pull-top containers, the lid opening device becomes more versatile and convenient.

According to the present invention, it is preferred that both the extending section have appropriate elasticity and stiffness for opening/closing, and for this reason, an appropriate length between a circular arc-shaped section and a front end of each extending section is about 60 mm to 150 mm. A thickness and a width of the lid opening device fall within the range of 0.3 mm to 1.5 mm and within the range of 5 mm to 20 mm, respectively, and can be properly set according to size of the cap, and gender and age of main users.

### Embodiment 1

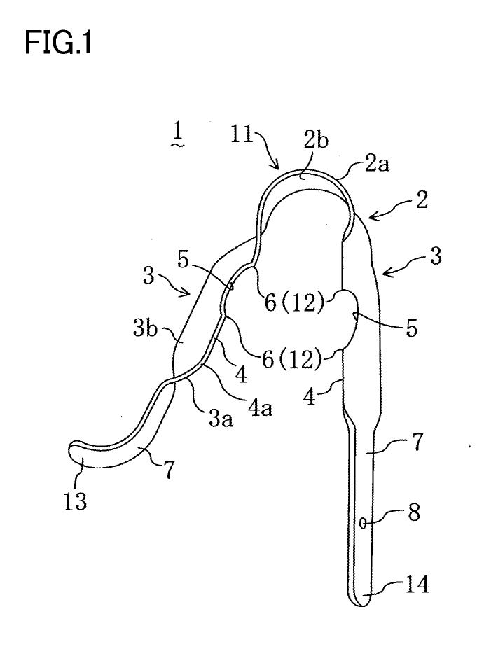

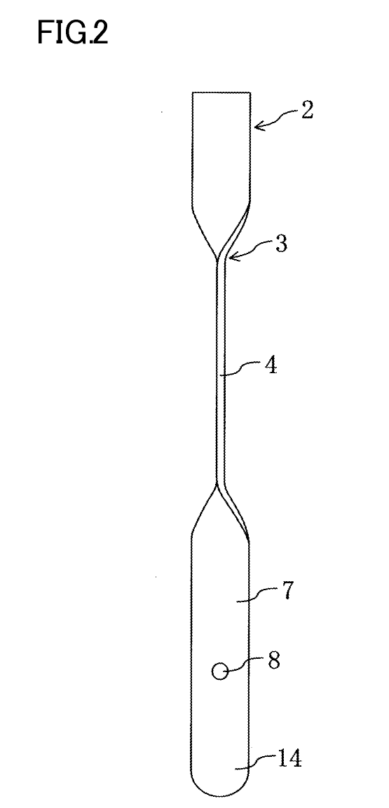

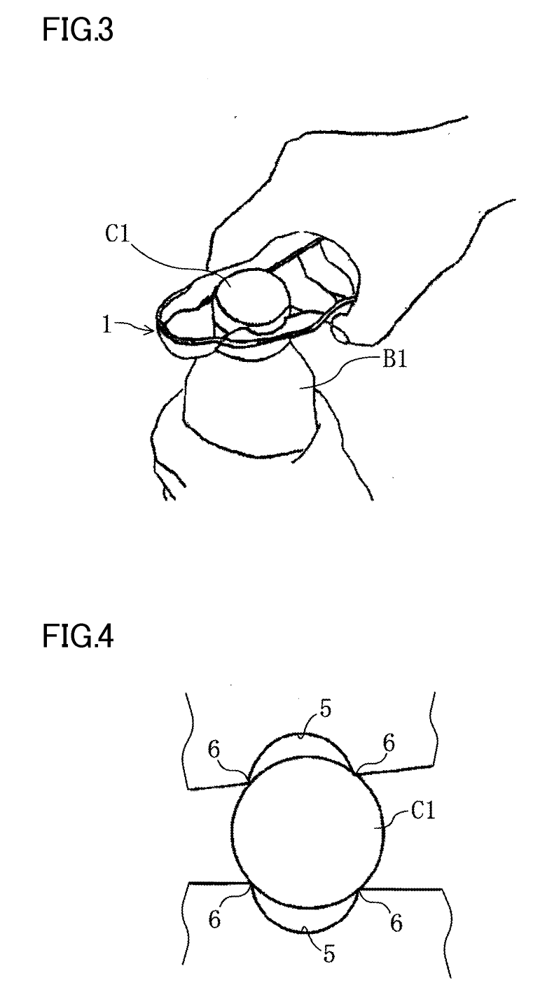

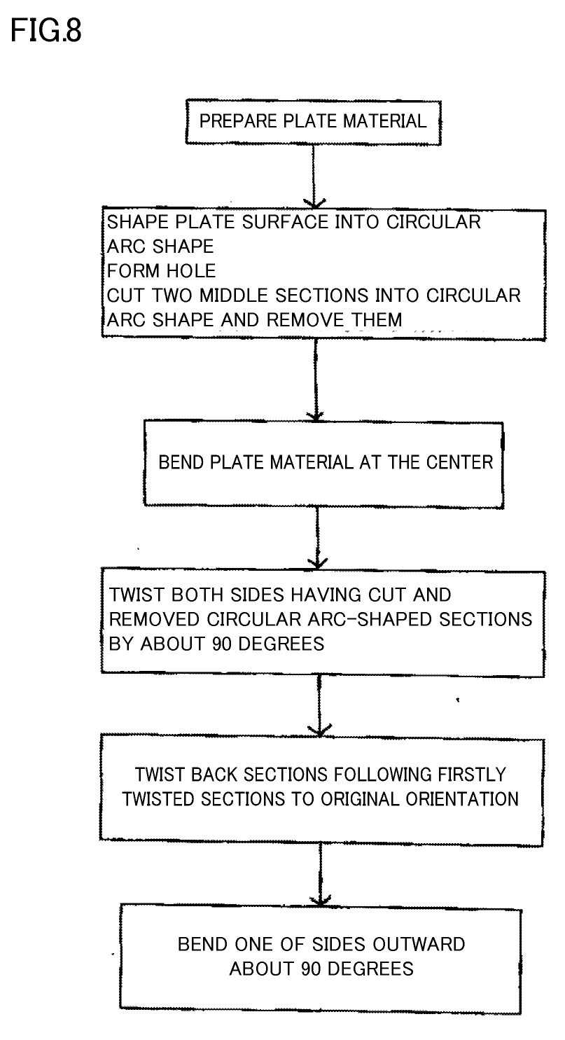

FIG. 1 is a perspective view of a lid opening device in accordance with Embodiment 1. FIG. 2 is a side view of the lid opening device in accordance with Embodiment 1. FIG. 3 to FIG. 6 are explanation views for explaining usage conditions of the lid opening device shown in FIG. 1. FIG. 7 shows a state of a plate material prior to forming of the lid opening device shown in FIG. 1 and FIG. 8 shows a manufacturing process of the lid opening device.

Preferably, the lid opening device 1 is comprised of a metallic plate material such as stainless, iron or aluminum material, which has a thickness of about 1.5 mm and a width of 10 mm. As shown in FIG. 1 and FIG. 2, the plate material is bent in the middle so that its plate surface is curved to constitute a circular arc-shaped section 2 that is about 24 mm in diameter and has an outer peripheral surface 2a and an inner peripheral surface 2b. This circular arc-shaped section 2 constitutes a first opening section (lid opening device) 11 in which the inner peripheral surface 2b can come in contact with an outer peripheral surface of a screw cap and rotate the screw cap, thereby opening the screw cap. The lid opening device 1 includes two extending sections 3, 3 that continuously extend from both ends of the first opening section 11 (circular arc-shaped section 2). The extending sections 3, 3 extending from the first opening section 11 have twisted sections 4, 4, respectively, which are formed by twisting plate surfaces 3a, 3b by about 90 degrees in opposite directions with respect to the plate surface of the first opening section 11. The twisted sections 4, 4 are formed so that their inner plate side edges 4a face each other. The twisted sections 4, 4 each are about 40 mm in length and a substantially circular arc-shaped notched section 5 having a diameter of about 25 mm is formed on each of the inner plate side edges 4a of the twisted sections 4, 4. Both ends of each of the notched section 5, that is, boundary sections between the notched section 5 and the plate side edges 4a on both sides of the notched section 5, constitute angular contact sections 6, 6. The contact sections 6, 6 constitute second opening sections 12 that can come in contact with the outer peripheral surface of the screw cap and rotate the screw cap, thereby opening the screw cap. The second opening sections 12 will be described in detail later.

Front ends of the extending section 3, which follow the twisted section 4, are twisted back by about 90 degrees in a direction opposite to the twisting direction of the twisted sections 4 to constitute grip sections 7. The front end of one grip section 7 is bent outward by about 90 degrees to constitute an inside cap with pull-tab opening section 13. The front end of the other grip section 7 is extended without being bent to constitute a pull-top opening section 14. Both of the inside cap opening section 13 and the pull-top opening section 14 have a rounded front end so as to be easily inserted into a pull-tab. A hole section 8 is formed on the pull-top opening section 14 so that the lid opening device can be hung by threading a string or the like through the hole section.

Next, the usage conditions of the lid opening device 1 will be described with reference to FIG. 3 to FIG. 6.

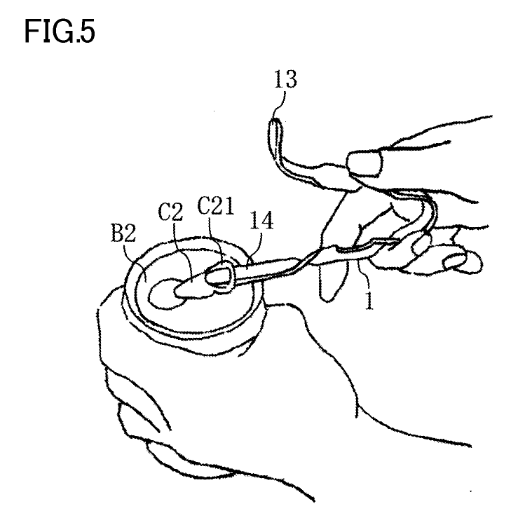

As shown in FIG. 3 and FIG. 4, when a screw cap C1 of a bottle B1 filled with mainly liquid such as juice, energy drinks, etc., is rotated and opened, the contact sections 6,6 are arranged so that the screw cap C1 is located between the contact sections 6,6 constituting the second opening sections 12. Then, the grip sections 7,7 are held to bring the four contact sections 6 into contact with the outer peripheral surface of the screw cap C1.

Typically, because the screw cap C1 for PET bottles and the like is about 28 mm in diameter and the notched section 5 is about 25 mm in diameter, the four contact sections 6, not the inner peripheral surfaces of the notched sections 5, are in contact with the outer peripheral surface of the screw cap C1. As a result, since the four edge-like contact sections 6 hold the screw cap C1 at a higher position than the circumference, when the lid opening device 1 is rotated, the screw cap C1 can be rotated without sliding the four contact sections 6 on the outer peripheral surface of the cap. Especially since the twisted sections 4 are provided and the contact sections 6 are formed in the plate side edges 4a of the twisted sections 4, even when the grip sections 7,7 are held with a weak force, the contact pressure of the contact sections 6 against the outer peripheral surface of the screw cap C1 is high and thus, the cap C1 can be rotated while reliably grasping the outer peripheral surface of the screw cap C1 without any slip and.

Although the contact sections 6 are provided at four positions in Embodiment 1, the number of positions is not limited to four and may be three or more than four. When the contact sections 6 of the twisted sections 4, 4 are provided at even number of positions so that the contact sections 6,6 placed on both sides are opposed to each other, the screw cap C1 becomes difficult to deform when grasped, which advantageously enables easy rotation. That is, when the four contact sections 6 are positioned symmetrically about the center of the screw cap C1, in grasping the screw cap C1, a substantially equal force is applied to the cap C1 from both sides and the cap C1 is difficult to deform. Thus, the cap C1 can be easily rotated and handled with a weak force.

To grasp the cap C1, it is more preferred that the contact sections 6 are angular like edges than are smooth plane. When operating the lid opening device 1 with a hand, as shown in FIG. 3, the user may hold the grip sections 7 on the front sides of the twisted sections 4 or may hold outer sides of the twisted sections 4.

With reference to FIG. 5, a case will be described where a pull-top can such as a beverage can filled with beer, juice or the like is opened. The pull-top opening section 14 of the lid opening device 1 is inserted into a hole section C21 on a pull-tab C2 of a can B2 and moved in a direction of pushing the twisted section 4 downward (clockwise direction in FIG. 5). By this operation, the pull-top opening section 14 is pulled up using a middle portion of the grip section 7, which is supported by an edge of the can B2, as a fulcrum, thereby pulling up the pull-tab C2 to open the can. In such manner, the pull-tab C2 can easily be pulled up with a weak force to open the can. Alternatively, the pull-tab C2 can be pulled up to open the can by inserting the pull-top opening section 14 into the hole section C21 on the pull-tab C2 of the can B2 in a direction of pushing the twisted section 4 upward (counterclockwise direction in FIG. 5) without using the principle of the lever.

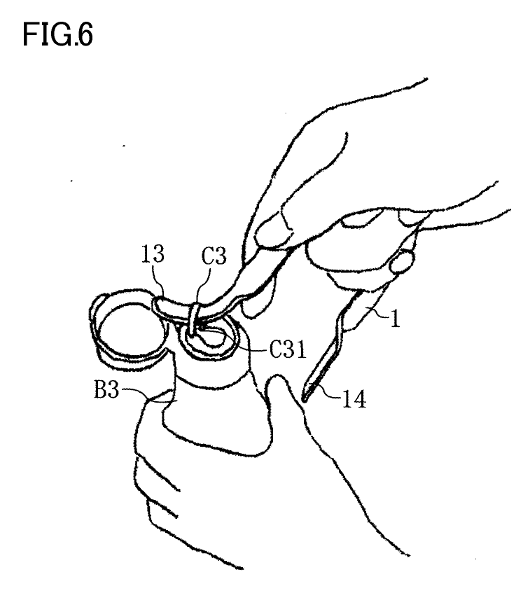

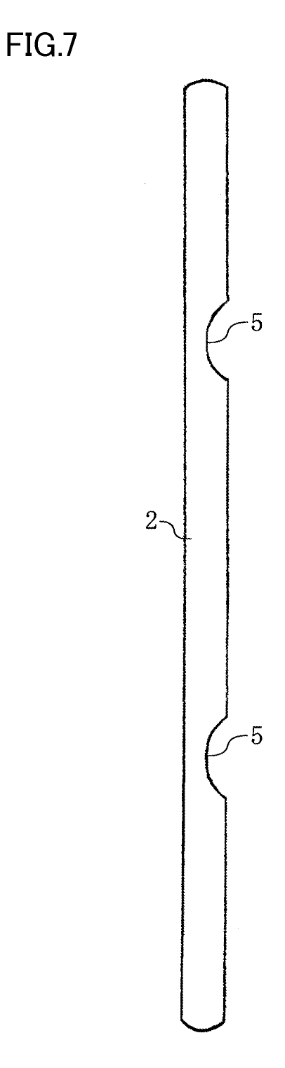

With reference to FIG. 6, a case will be described where a bottle with a cap and an inside cap, such as a seasoning bottle, is opened. As shown in FIG. 6, to open an inside cap with pull-tab C3 provided on a seasoning bottle B3, in place of inserting a finger into the hole section C31, the inside cap opening section 13 formed at the front end of the grip section 7 of the lid opening device 1 is inserting into a hole section C31 and the inside cap C3 is pulled upward. Also in this case, the cap can be opened without need to insert the finger into the hole section C31, causing no damage of a nail. A bending angle of the inside cap opening section 13 is not limited to an angle in the structure in this embodiment and may be appropriately set depending on the intended use.

In use of the second opening section 12, the circular arc-shaped first opening section 11 acts as the fulcrum of the lever and can be also used to rotate and open the screw cap. In the latter case, the first opening section 11 is wound around the screw cap and fastens the outer peripheral surface of the cap tightly while the extending sections 3, 3 (grip sections 7, 7) are held, and in this state, the lid opening device 1 is rotated. It is more preferred to form non-slip irregularities on the inner peripheral surface of the first opening section 11.

A grip strength of the grip sections 7 when held in operation can be changed by adjusting material, thickness, etc. of the lid opening device 1. In order to decrease the grip strength, for example, the first opening section 11 may be provided with a slit extending in its circumferential direction for easiness of bending. This slit may be formed in the center in a width direction, on one side or on both sides. Further, in order to increase a frictional force (contact pressure), a cut and bent section or an end section occurred by forming the slit, like the angular contact sections 6, may be used as a protrusion section capable of coming contact with the outer peripheral surface of the cap. In order to increase the grip strength, a rib extending in the circumferential direction, not the slit, may be formed on the first opening section 11.

In Embodiment 1, since the front ends of the extending section 3, 3 are opened therebetween (that is, the front ends are separated from each other and are not integrated), a distance between the front ends of the extending section 3, 3 can be easily adjusted to be increased or decreased. Through this adjustment, a cap having a diameter of about 27 to 40 mm, for example, can be grasped between the second opening sections 12, 12 and opened. When an attempt is made to grasp and rotate a cap having a diameter less than 25 mm, the notched sections 5 with a reduced diameter may be prepared.

Next, with reference to FIG. 7 and FIG. 8, a method of manufacturing the lid opening device 1 will be described. An elongate plate material having predetermined thickness and width is prepared. Next, the notched sections 5 are formed at two positions away from the center of the plate material in opposite directions and front ends as the grip sections 7 are rounded. The hole section 8 is formed on one grip section 7. After shaping of the plate material into this state, a central portion of the plate material is bent by a rotational angle of about 150 degrees so that the whole of the plate material becomes substantially U-shaped to constitute the first opening section 11 having a circular arc-shaped plate surface. The extending sections 3 extending from both ends of the first opening section 11 are twisted at midpoints by about 90 degrees relative to the plate surface of the first opening section 11 to form the twisted sections 4. Front ends of the extending sections 3, which follow the twisted sections 4, are twisted back to the original orientation to constitute the grip sections 7. Then, a front end of one grip section 7 is bent outward to constitute the inside cap opening section 13.

This manufacturing process is merely an example, and thus, does not limit manufacturing process of the present invention.

Although the extending sections 3 are twisted back from the twisted sections 4 to the original orientation to form the grip sections 7, the extending sections 3 may be twisted in the same direction as the first twisting direction. Alternatively, the front ends of the extending sections 3 may be kept in the same orientation as the twisted sections 4 without being twisted back to form the grip sections. In this case, fingers and a palm come in contact with the plate side edges of the extending section 3. When the contact feeling is uncomfortable, the extending sections 3 each may be covered with a cover member to improve the contact feeling of fingers and palm.

An irregular locking surface for preventing slip may be formed on the inner peripheral surface of the first opening section 11.

Although the grip section 7 is bent outward to constitute the inside cap opening section 13, a bending direction is not limited to the outward direction and may be an inward direction or other directions. Although the grip section 7 is bent by about 90 degrees, a bending angle may be any angle that is suitable for opening the inside cap and is not limited to 90 degrees. In this embodiment, the inside cap opening section 13 is bent, while the pull-top opening section 14 is not bent. However, both of the inside cap opening section 13 and the pull-top opening section 14 need not be bent or may be bent.

A string for suspension may be passed through the hole section 8, or a decoration such as a strap for cell phone may be attached to the hole section 8. Alternatively, the hole section 8 may be omitted.

The shape of the notched sections 5 is not limited to a circular arc and the notched sections 5 may take any shape including an ellipse and a rectangle as long as the contact sections 6 can be formed thereon. In the case of the rectangular notched section, when there is a need to prevent a stress from concentrating on its corners, R (roundness) may be applied to the corners. Further, the rectangular notched section may function as a screwdriver for turning a head of a hexagonal bolt. Although the right and left notched sections 5 have the same size, they are not necessarily same and may be different.

The lid opening device with a simple structure in Embodiment 1 can be widely used as an opener for pull-top containers, an opener for screw caps of paper containers, an opener for inside caps of seasoning bottles and the like.

### Embodiment 2

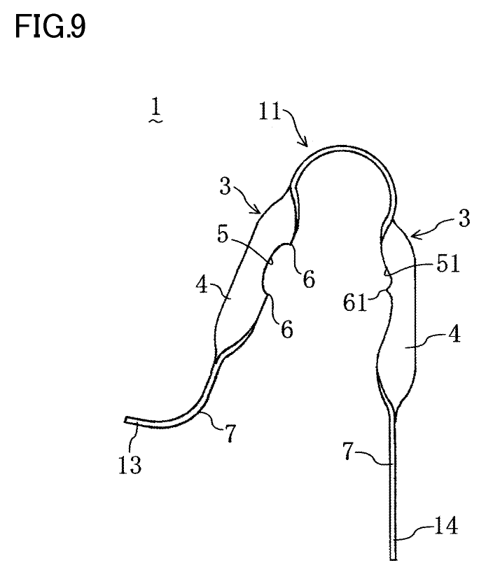

Embodiment 2 will be described with reference to FIG. 9. FIG. 9 is similar to FIG. 1 in accordance with Embodiment 1. Here, only a difference between Embodiment 2 and Embodiment 1 is described and description of their similarities is omitted. Embodiment 2 is different from Embodiment 1 in that, the two contact sections 6, 6 are formed on one twisted section 4 as in Embodiment 1, while only one angular contact section 61 is formed on the other twisted section 4. A portion between the two contact sections 6, 6 of the one twisted section 4 is opposed to the contact section 61 of the other twisted section 4 and the screw cap is grasped by the three contact sections 6, 6 and 61. Notched sections 51 on both sides of the contact section 61 each are shaped like a smoothly curved depression so as to be hardly damaged. In Embodiment 2, since there are three contact points against the outer peripheral surface of the cap and the contact section 61 are shifted from the contact sections 6, 6 in position, the screw cap can be sufficiently grasped even with a weak force. When the screw cap is not a relatively soft resin cap, like a cap of the PET bottle, but a metal cap and requires a relatively large rotational force or a larger grasping force for opening, Embodiment 2 is preferable. In Embodiment 2, the lid opening device 1 with the contact sections 6, 6 and the contact section 61 can be also used to open a crown cap for beer bottles and the like, that is, act as a bottle opener.

### Embodiment 3

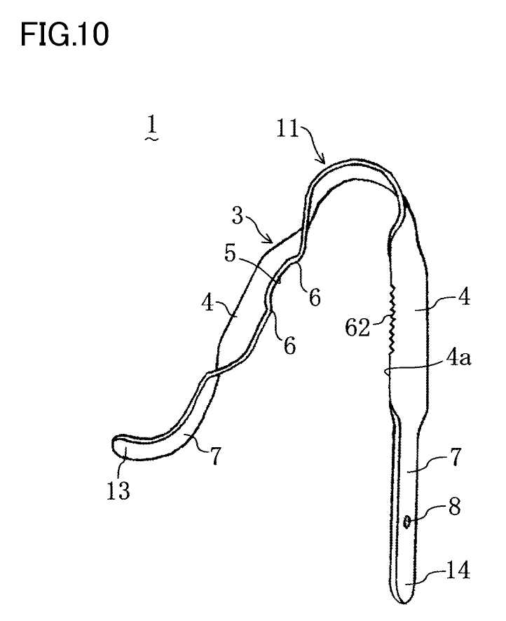

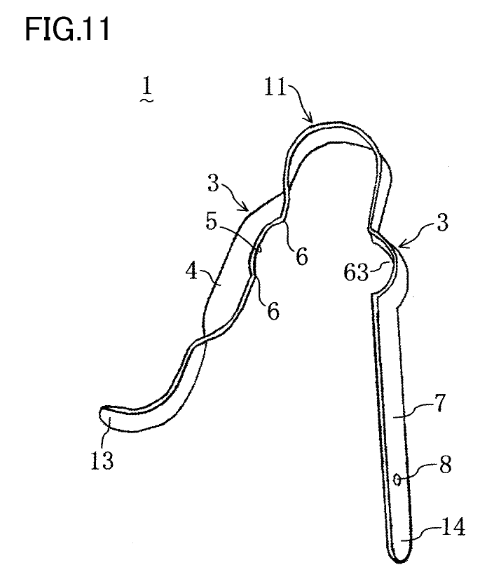

Embodiment 3 will be described with reference to FIG. 10. FIG. 10 is similar to FIG. 1 in accordance with Embodiment 1. Here, only a difference between Embodiment 3 and Embodiment 1 is described and description of their similarities is omitted. Embodiment 3 is different from Embodiment 1 in a structure of a contact section 62 formed on the other twisted section 4. That is, the notched section 5 is not formed on the other twisted section 4, and a contact section 62 having serrated irregularities is formed on the inner plate side edge 4a. This lid opening device can be used to open various screw caps having different diameters, which is versatile. In Embodiment 3, the lid opening device 1 with the contact sections 6, 6 and the contact section 62 can be also used to open the crown cap for beer bottles and the like, that is, act as the bottle opener.

### Embodiment 4

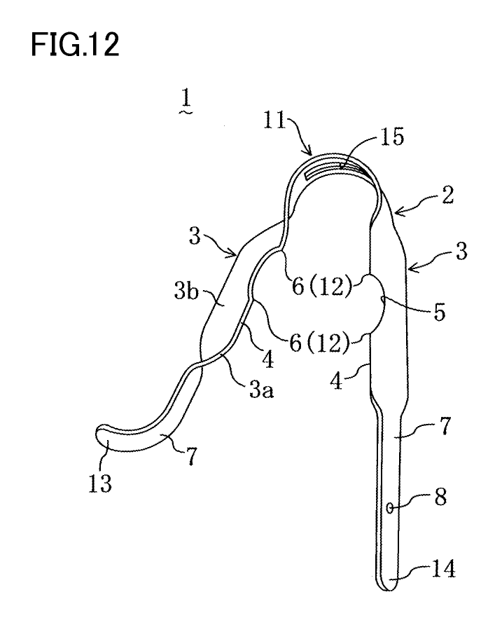

Embodiment 4 will be described with reference to FIG. 11. FIG. 11 is similar to FIG. 1 in accordance with Embodiment 1. Here, only a difference between Embodiment 4 and Embodiment 1 is described and description of their similarities is omitted. Embodiment 4 is different from Embodiment 1 in that the twisted section 4 is formed on one extending section 3, while the twisted section is not formed and a contact section 63 of another shape is formed on the other extending section 3. That is, the contact section 63 having a substantial semicircular cross section is formed on the other extending section 3. In this case, because the whole of the contact section 63 comes contact with the outer periphery of the screw cap, it is preferred to provide a non-slip. As distinct from Embodiments 1 and 2, this embodiment does not require the steps of twisting and twisting back the other extending section 3, and therefore, the manufacturing process can be simplified. In addition, since the other extending section 3 has no twisted section, the opener is advantageously easy to grasp.

Further, the lid opening device 1 with the contact sections 6, 6 and the contact section 63 can be used to open the crown cap for beer bottles and the like, that is, act as the bottle opener. In this case, the crown cap can be opened by covering both ends of the arcurate contact section 63 onto the crown cap, hooking the contact sections 6, 6 on an edge of the crown cap and twisting the lid opening device 1.

### Embodiment 5

Embodiment 5 will be described with reference to FIG. 12. FIG. 12 is similar to FIG. 1 in accordance with Embodiment 1. Here, only a difference between Embodiment 5 and Embodiment 1 is described and description of their similarities is omitted. Embodiment 5 is different from Embodiment 1 in that the first opening section 11 is provided with a slit 15 extending in its circumferential direction so as to easily bend the first opening section 11, resulting in that even physically weak persons such as elderly persons and children can operate the lid opening device 1 with a weak force.

Length, size and position of the slit each vary depending on quality, strength and thickness of material and may be adjusted to a predetermined value corresponding to an operational force. The slit may be formed at one location or several locations.

### Embodiment 6

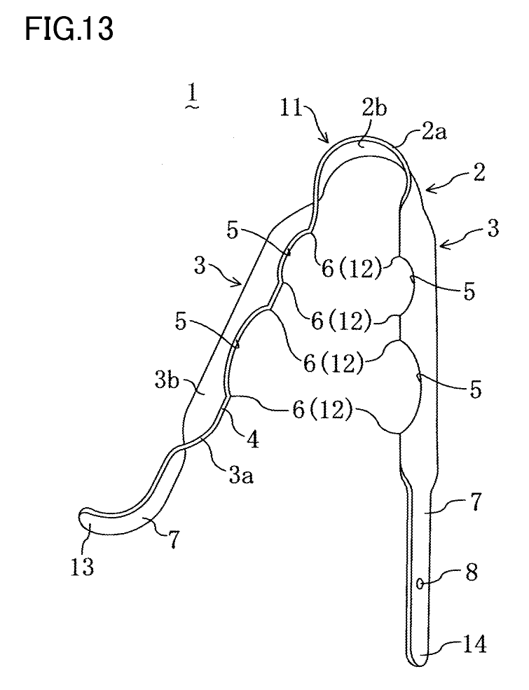

Embodiment 6 will be described with reference to FIG. 13. FIG. 13 is similar to FIG. 1 in accordance with Embodiment 1. Here, only a difference between Embodiment 6 and Embodiment 1 is described and description of their similarities is omitted. Embodiment 6 is different from Embodiment 1 in that two notched sections 5 each having contact sections 6 at its both ends are formed on each of the two extending sections 3, 3. Because the notched sections 5 located closer to the first opening section 11 are made small and the notched sections 5 located further from the first opening section 11 are made large, this lid opening device can be widely applied to various caps having different diameters. Some caps having certain diameters may be opened by both of the small and large notched sections 5, 5. In this case, the user may select and use either of the notched sections 5, 5 based on easiness to grasp or operation.

Although the two notched sections 5, 5 formed on each extending section 3 are different from each other in size in Embodiment 6, they may be identical in size, or conversely, it is also possible to made the notched sections 5 located closer to the first opening section 11 large and the notched sections 5 located further from the first opening section 11 small. The number of the notched sections 5 formed on each extending section 3 is limited to two and may be three or more. The notched sections 5 of one extending section 3 may be different from the notched section 5 of the other extending section in size. One or both of the notched section 5 located closer to and further from the first opening section 11 may be formed on only one extending section, not on the other extending section.

In Embodiment 6, since a distance between the notched section 5 located closer to the first opening section 11 and the grip section 7 becomes relatively long, even when a holding force applied to the grip sections 7, 7 is small, the contact sections 6 at both ends of the notched section 5 can be strongly pressed onto the screw cap C1.

### Embodiment 7

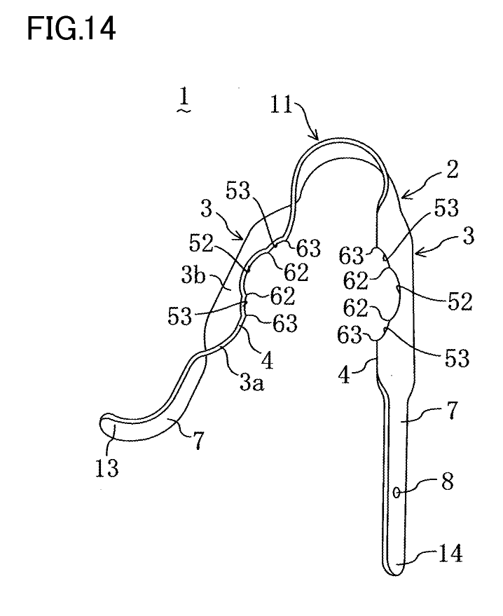

Embodiment 7 will be described with reference to FIG. 14. FIG. 14 is similar to FIG. 1 in accordance with Embodiment 1. Here, only a difference between Embodiment 7 and Embodiment 1 is described and description of their similarities is omitted. Embodiment 7 is different from Embodiment 1 in that two-staged notched sections 5 and two-staged contact section 6 are provided. That is, a large-diameter notched section 53 and a small-diameter notched section 52 are provided on each extending section 3 in two stages, contact sections 62 are provided at both ends of the small-diameter notched section 52 and contact sections 63 are provided at both ends of the large-diameter notched section 53. In this case, the cap opening operation can be performed by bringing the contact sections 63 into contact with a large-diameter cap and the contact sections 62 into contact with a small-diameter cap.

In Embodiment 7, even when the extending section 3 is not extended, various cap having different diameters can be opened. It is also possible to provide the large-diameter notched section 53 and the small-diameter notched section 52 on only one extending section 3 and provide either large-diameter notched section 53 or small-diameter notched section 52 on the other extending section 3. Embodiment 7 can be applied to the larger notched sections in Embodiment 6.

### Embodiment 8

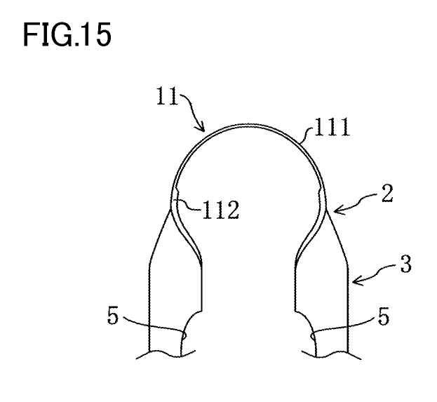

Embodiment 8 will be described with reference to FIG. 15. FIG. 15 is a front view showing the first opening section 11. Other structures are the same as those in Embodiment 1 shown in FIG. 1 and description thereof is omitted. Embodiment 8 is different from Embodiment 1 in that the circular arc-shaped portion of the first opening section 11 is constituted of a thin-walled section 111 having a thin thickness so that the first opening section 11 becomes easy to bend. In Embodiment 8, the first opening section 11 is easy to bend, which is suitable for use by physically weak elderly persons and children.

Although the thickness of the thin-walled section 111 is about a half of another thick-walled section 112, it is limited to this thickness. A plurality of thin-walled sections 111 and a plurality of thick-walled sections 112 may be alternately provided in the circumferential direction.

The thin-walled section 111 in Embodiment 8 may be provided in place of the slit in Embodiment 5 as shown in FIG. 12, or added to the slit in Embodiment 5 as shown in FIG. 12.

### Embodiment 9

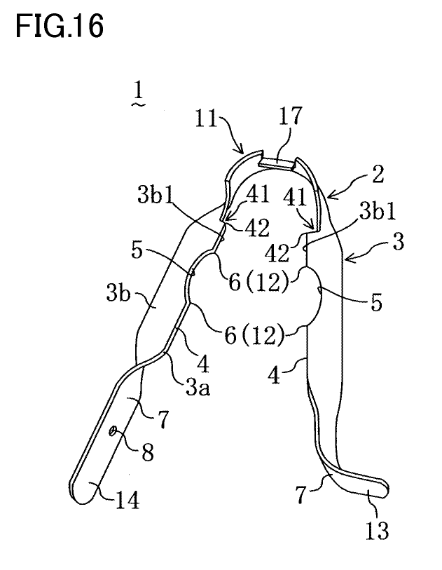

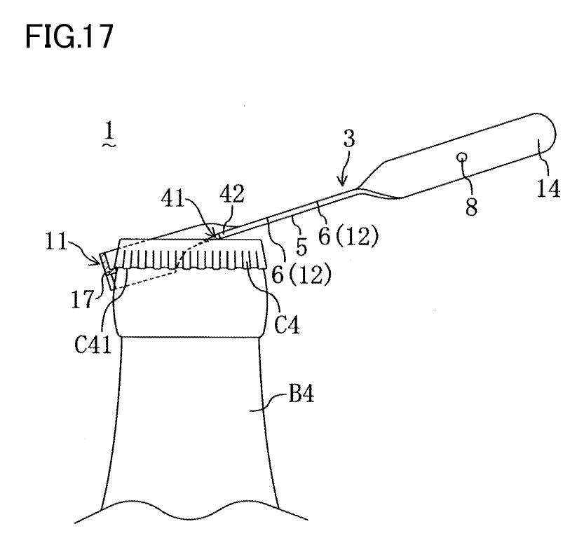

Embodiment 9 will be described with reference to FIG. 16 and FIG. 17. FIG. 16 is similar to FIG. 1 in accordance with Embodiment 1. Here, only a difference between Embodiment 9 and Embodiment 1 is described and description of their similarities is omitted. Embodiment 9 is different from Embodiment 1 in that a bottle opener structure is provided on the first opening section 11. In other words, a circumferentially-extending plate side edge in the middle of the first opening section 11 is cut and bent, that is, is bent by about 90 degrees to form a bent section 17. Sections 41 that are twisted inward from the first opening section 11 and connected to the corresponding twisted sections 4 are partially cut off and edges of the twisted sections 4 that face the cut-off sections form fulcrum sections 42 for opening a cap. Since the inside cap opening section 13 and the pull-top opening section 14 in Embodiment 1 may be reversely arranged, reversed arrangement is adopted in Embodiment 9.

A state where the bottle opener structure in Embodiment 9 is used as the bottle opener for beer bottles will be described with reference to FIG. 17. To clearly illustrate a state where the bent section 17 is engaged with a lower edge C41 of a cap (crown cap) C4 of a beer bottle B4, FIG. 17 shows a cross section of the lid opening device 1 separated into left and right across its center.

When used, as shown in FIG. 17, the bent section 17 is engaged with the lower edge C41 of the cap C4 of the beer bottle B4, thereby bringing the fulcrum sections 42 into contact with an upper surface of the cap C4. Then, in FIG. 17, the lid opening device 1 is rotated in the clockwise direction using the fulcrum sections 42 as fulcrums. Whereby, the bent section 17 is lifted up together with the edge C41 of the cap C4, resulting in that the cap C4 is detached from the beer bottle B4.

Although the inwardly-twisted sections 41 of the plate material are partially cut off in Embodiment 9, the cut-off is not essential and can be omitted. That is, the twisted sections 4 or the extending sections 3 in the as-is status may be used as fulcrum sections for contact against the upper surface of the cap C4.

### Embodiment 10

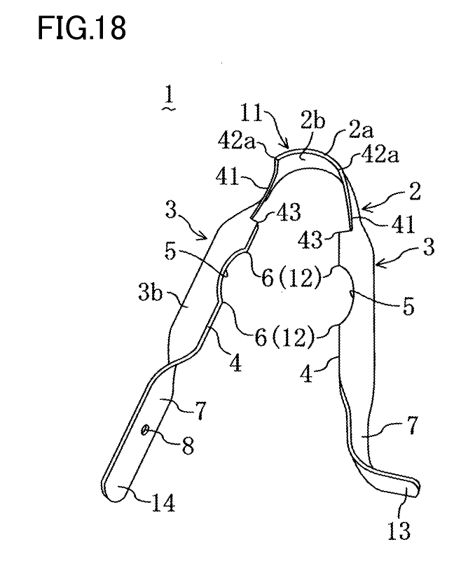

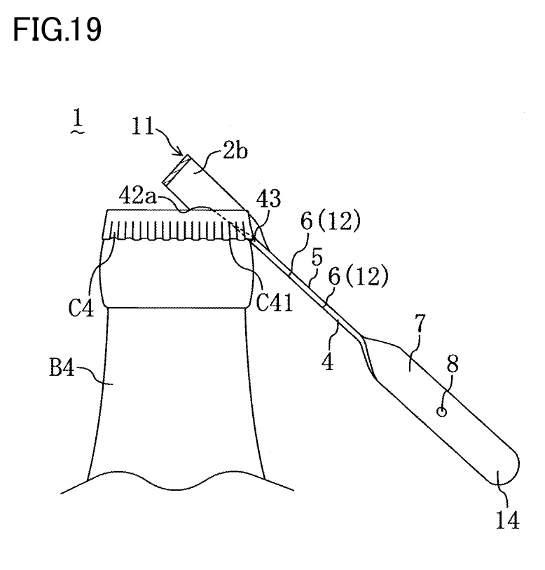

Embodiment 10 will be described with reference to FIG. 18 and FIG. 19. FIG. 18 is similar to FIG. 1 in accordance with Embodiment 1. Here, only a difference between Embodiment 10 and Embodiment 1 is described and description of their similarities is omitted. Similar to Embodiment 9, Embodiment 10 is different from Embodiment 1 in that a bottle opener structure is provided on the first opening section 11. That is, sections 41 that are twisted inward from the first opening section 11 and connected to the corresponding twisted sections 4 are partially cut off and edges of the cut-off sections on the side of the twisted sections 4 form engaging sections 43 for opening a cap. Edges of the cut-off sections on the side of the first opening section 11 form fulcrum sections 42a for opening a cap. Since the inside cap opening section 13 and the pull-top opening section 14 in Embodiment 1 may be reversely arranged, reversed arrangement is adopted in Embodiment 10.

A state where the bottle opener structure in Embodiment 10 is used as a bottle opener for beer bottles will be described with reference to FIG. 19. FIG. 19 shows a cross section of the lid opening device 1 separated into left and right across its center.

When used, as shown in FIG. 19, the engaging sections 43 are engaged with the edge C41 of the cap (crown cap) C4 of the beer bottle B4 and the fulcrum sections 42a provided on the first opening section 11 are brought into contact with the upper surface of the cap C4. Then, the lid opening device 1 is rotated in the counterclockwise direction in FIG. 19 using the fulcrum sections 42a in contact with the upper surface of the cap C4 as fulcrums. Whereby, the engaging sections 43 are lifted up together with the edge C41 of the cap C4, resulting in that the cap C4 is detached from the beer bottle B4.

In Embodiment 10, a structure like the bent section 17 in Embodiment 9 may be provided on the first opening section 11 to constitute a fulcrum section. Although the sections 41 that are twisted inward from the first opening section 11 and connected to the corresponding twisted sections 4 are partially cut off to form the engaging sections 43 and the fulcrum sections 42a, it is also possible to extend the cut-off area to the whole area of the first opening section 11 and define a central section of the first opening section 11 as a fulcrum section. That is, the thickness of the first opening section 11 is made a half of that of the extending section 3. According to this embodiment, a lid opening device can be used as the bottle opener by forming the engaging sections 43 and providing a fulcrum on the first opening section 11, and however, structures of the engaging section 43 and the fulcrum section 42a are not limited to the above-mentioned structures.

### Embodiment 11

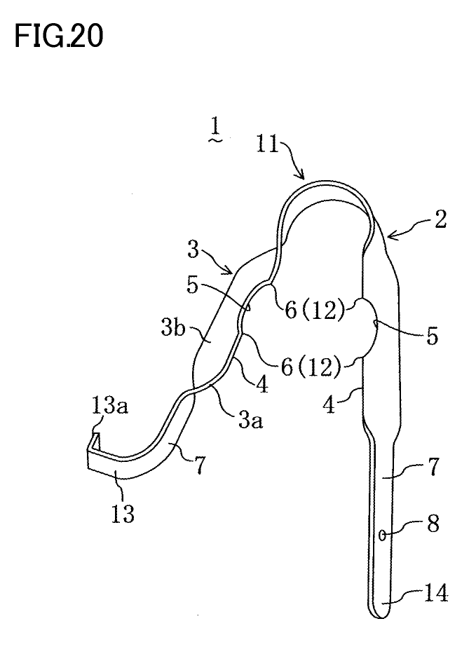

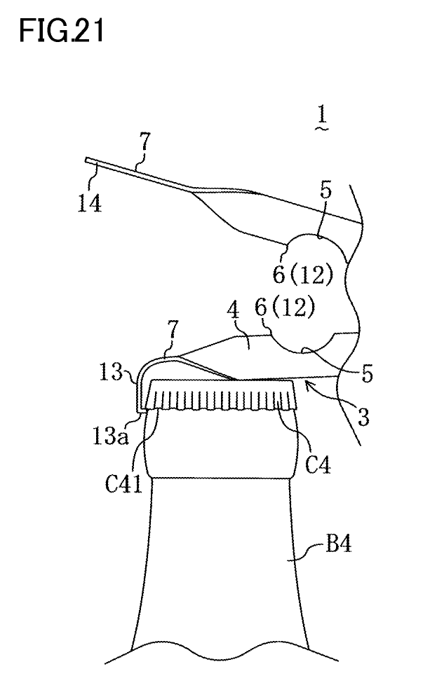

Embodiment 11 will be described with reference to FIG. 20 and FIG. 21. FIG. 20 is similar to FIG. 1 in accordance with Embodiment 1. Here, only a difference between Embodiment 11 and Embodiment 1 is described and description of their similarities is omitted. Embodiment 11 is different from Embodiment 1 in that the inside cap opening section 13 is provided with a bottle opener structure. That is, a front end of the inside cap opening section 13 is bent substantially at right angles toward the first opening section 11 to form an engaging section 13a.

A state where the bottle opener structure in Embodiment 11 is used as the bottle opener for beer bottles will be described with reference to FIG. 21. When used, as shown in FIG. 21, the engaging section 13a is engaged with the edge C41 of the cap (crown cap) C4 of the beer bottle B4 and the twisted sections 4 are brought into contact with the upper surface of the cap C4. Then, the lid opening device 1 is rotated in the clockwise direction in FIG. 21 using the twisted sections 4 in contact with the upper surface of the cap C4 as fulcrums. Whereby, the engaging sections 13a is lifted up together with the edge C41 of the cap C4, resulting in that the cap C4 is detached from the beer bottle B4.

Although the engaging section 13a is provided at the inside cap opening section 13 in Embodiment 11, the present invention is not limited to this and an engaging section like the engaging section 13a may be provided at the pull-top opening section 14.

Although the engaging section 13a is bent toward the first opening section 11, it may be bent in the opposite direction. The engaging section 13a may be used as the inside cap opening section. Alternatively, it is possible to vertically split the front end of the grip section 7 to use one side as the inside cap opening section 13 and the other side as the engaging section 13a.

The structure of the lid opening device is not limited to the above-mentioned one and may be other structures. Although the bottle opener structure is added to the lid opening device in Embodiment 1 in this embodiment, the above-mentioned bottle opener structure may be added to the lid opening device in the other embodiment other than Embodiment 1.

### Other Embodiments

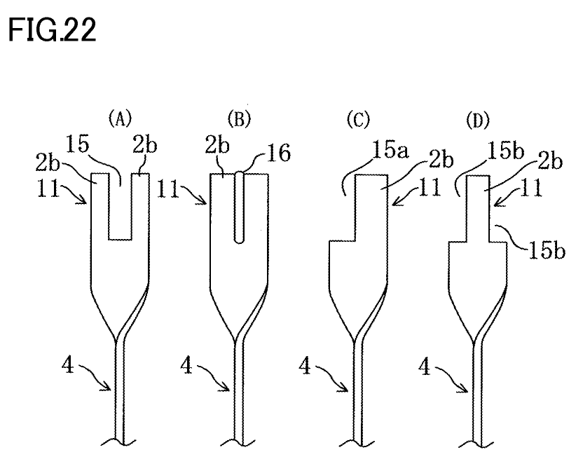

FIG. 22 are side views showing examples of the first opening section 11 modified so as to be easy to bend the first opening section 11 or increase stiffness of the first opening section 11.

FIG. 22(A) shows a lid opening device having the slit 15 in Embodiment 5 shown in FIG. 12. The slit 15 is provided at the center of the first opening section 11 in the width direction to be easy to bend the first opening section 11. This structure is described in Embodiment 5 with reference to FIG. 12 and thus, detailed description thereof is omitted. This description of FIG. 22(A) is for comparison with other embodiments.

FIG. 22(B) shows another embodiment with a rib 16 in place of the slit 15. In this embodiment, contrary to Embodiment 5, bending strength of the first opening section is increased. That is, the strength of the first opening section 11 is decreased so that the first opening section 11 is easily bent in Embodiment 5, while the extending section 3 is easily bent and the first opening section 11 has a relatively high strength to extend its life in this embodiment shown in FIG. 22(B). Although the rib 16 is formed at one central position, the structure of the rib is not limited to this and position, size and the number of rib may be appropriately set.

FIG. 22(C) shows another embodiment in which in place of providing the slit in Embodiment 5, the plate material main body 2 is cut by half in the width direction so that the first opening section 11 is easily bent. The width of the plate material is not necessarily decreased by half and may be another width, that is, may be properly defined.

FIG. 22(D) shows still another embodiment in which in place of providing the slit in Embodiment 5, both sides of the plate material main body 2 are cut in the width direction so that the first opening section 11 is easily bent.

As described above, the structure of the first opening section 11 may be variously modified and is not limited to the structures in the above-mentioned embodiments.

Although the first opening section is provided in all of the above-mentioned embodiments, the circular arc-shaped section 2 may be used as merely an elastic bending fulcrum without being used as the first opening section. Further, the extending sections only may constitute the grip sections without providing the inside cap opening section and the pull-top opening section.

The twisting direction of the two opposed twisted sections 4, 4 is not limited to the direction in the embodiments and may be any direction. For example, both the twisted sections 4, 4 may be twisted in the same direction or in opposite directions. Although the grip sections 7 are twisted back from the twisted sections 4 to the original orientation, the grip sections 7 may be twisted in any direction, for example, may be twisted in the same direction or different directions.

Each of the above-mentioned embodiments may be combined with the other embodiments.

The front ends of the inside cap opening section 13 and the pull-top opening section 14 each may be formed like a screwdriver (driver or wrench).

Possible plate materials for the lid opening device include metal such as iron, stainless and aluminum as well as synthetic resin.

The surface of the lid opening device may be coated with an antirust agent, a decorative material or a surface treatment agent for improving feeling when held according to a surface treatment method such as plating and coating. Alternatively, another surface member may cover section or whole of the surface of the lid opening device.

### INDUSTRIAL APPLICABILITY

The present invention can be applied to a lid opening device capable of easily opening pull-top cans filled with beer, juice or the like, screw caps of containers filled with juice, energy drinks, etc., and inside caps of seasoning bottles. The can opener can be also configured as a bottle opener for beer bottles.

### DESCRIPTION OF REFERENCE CHARACTERS

1 Lid opening device
2 Plate material main body
3 Extending section
4 Twisted section
5 Notched section
6 Contact section
7 Grip section
8 Hole section
11 First opening section
12 Second opening section
13 Inside cap opening section
14 Pull-top opening section
15 Slit
16 Rib
17 Bent section

1. A container lid opening device comprised of a plate material comprising:
a circular arc-shaped section formed by bending a plate surface into a circular arc shape; and
two opposed extending sections continuously extending from opposite ends of the circular arc-shaped section, wherein
at least one extending section includes a twisted section that is formed by twisting the plate surface so that a plate side edge faces the other extending section, and a contact section that is to be in contact with an outer peripheral surface of a screw cap of a container is formed on the plate side edge of the twisted section in order to grasp and rotate the screw cap in cooperation with the other extending section.

2. The container lid opening device as stated in claim 1, wherein
a notched section is formed on the plate side edge of the twisted section and angular sections at both ends of the notched section constitute the contact section.

3. The container lid opening device as stated in claim 1, wherein
the contact section is formed on the plate side edge of each of the two extending sections.

4. The container lid opening device as stated in claim 3, wherein
the contact sections formed on the plate side edges of the two extending sections are opposed to each other.

5. The container lid opening device as stated in claim 1, wherein
opposed grip sections are formed at both front ends of the extending sections so that the plate surfaces of the extending sections are opposed to each other.

6. The container lid opening device as stated in claim 5, wherein
a front end of at least one of the grip sections of both the extending sections is bent inward or outward to constitute a pull-tab hook to be engaged with a pull-tab in order to open a cap with pull-tab.

7. The container lid opening device as stated in claim 5, wherein
a front end of at least one of the grip sections of both the extending sections constitutes a pull-tab hook to be engaged with a pull-tab in order to open a pull-top container.

8. The container lid opening device as stated in claim 5, wherein
a front end of one grip section of both the extending sections is bent inward or outward to constitute a pull-tab hook to be engaged with a pull-tab in order to open a cap with pull-tab, and
a front end of at least one of the grip sections of both the extending sections constitutes a pull-tab hook to be engaged with a pull-tab in order to open a pull-top container.

9. The container lid opening device as stated in claim 1, wherein
a winding section to be wound around the outer peripheral surface of the cap is formed on the inner peripheral surface of the circular arc-shaped section in order to rotate the cap.

10. The container lid opening device as stated in claim 1, wherein
the circular arc-shaped section is provided with a strength reducing section that reduces a force required to deform the circular arc-shaped section so as to reduce a radius of curvature of the circular arc-shaped section.

11. The container lid opening device as stated in claim 1, wherein
an engaging section to be engaged with an edge of a crown cap is provided at a front end of one grip section in order to use the grip section as a bottle opener.

12. The container lid opening device as stated in claim 1, wherein
an engaging section to be engaged with an edge of a crown cap is provided at the circular arc-shaped section in order to use the circular arc-shaped section as a bottle opener.
